(19) United States
(12) Patent Application Publication
(10) Pub. No.: US 2015/0195656 A1
(43) Pub. Date: Jul. 9, 2015

(54) New-Type Microphone Structure

(71) Applicants: Zilltek Technology (Shanghai) Corp., Shanghai (CN); Zilltek Technology Corp., Hsinchu City (TW)

(72) Inventor: Jinghua Ye, Shanghai (CN)

(21) Appl. No.: 14/308,522

(22) Filed: Jun. 18, 2014

(30) Foreign Application Priority Data
Jan. 3, 2014 (CN) 201410003492.X

(51) Int. Cl. H04R 17/00

(52) U.S. Cl. CPC H04R 17/00

(57) ABSTRACT

The invention relates to the technical field of voice processing equipment, more specifically, to a microphone. A new-type microphone structure comprises a first layer structure, a second layer structure located on the first layer structure, a microphone acoustic cavity formed by the first layer structure and the second layer structure, at least one acoustic hole for acquiring sound signals, which is arranged on the microphone acoustic cavity, and a dustproof component which covers the inside of the acoustic hole. The invention can prevent most of the dust particles and the moisture and the siphoning effect in actual use, which does not need to change the size of the existing microphone. It can be used in thin structures, and can prolong the service life of the microphone.

### RELATED APPLICATION(S)

This application claims the benefit of and priority to Chinese Patent Application No. 201410003492.X, filed on Jan. 3, 2014, which is incorporated by reference herein in its entirety.

### FIELD OF INVENTION

The invention relates to the technical field of voice processing equipment, more specifically, to a microphone.

### DESCRIPTION OF THE RELATED ART

With the development of the mobile multimedia technology, people's requirement on the sound quality is more and more highly. In the sound transmission design, the MEMS (Micro Electro Mechanical System Microphone) technology owns a thinner and smaller size, higher reliability, higher temperature resistance and other excellent characteristics in comparison with the traditional microphone, so that it's widely used for preventing the outside dust, liquid and other objects which will affect the performance form entering into the MEMS microphone. MEMS microphone is required to be produced and assembled in a clean room, however, the MEMS microphone inevitably would be affected by particles, such as dust, in external environment in actual use, which results in the degradation of the product performance and influences its service life.

The prior art aims to attach a dustproof layer net to the external surface of the acoustic hole in microphone, which will prevent the external dust particles entering into the inner of the microphone, however, the microphone monomer volume is changed, which takes more space and is unsuitable for the condition requiring the strict size. Meanwhile, the sound conducting rubber sleeve sheathed on the microphone has to change its size, which increases the production cost.

### SUMMARY OF THE INVENTION

The invention aims to provide a new-type microphone structure for solving the technical problems.

The invention solves the technical problems by the following technical solution:

A new-type microphone structure, comprising: a first layer structure and a second layer structure located on the first layer structure, a microphone acoustic cavity formed by the first layer structure and the second layer structure, at least one acoustic hole for acquiring sound signals is arranged on the microphone acoustic cavity, and a dustproof component covers the inside of the acoustic hole.

Preferably, the dustproof component is located on the inner surface of the microphone acoustic cavity.

Preferably, at least one portion of the acoustic hole is covered with the dustproof component.

Preferably, the acoustic hole is located on the first layer or the second layer to enable the microphone acoustic cavity to be connected with the outside.

Preferably, the dustproof component is a monolayer structure or a multilayer structure.

Preferably, the dustproof component is made of silicon based materials.

Preferably, the dustproof component is provided with a plurality of filter holes which forms into an array structure after the rearrangement.

Preferably, a transducer and a special integrated circuit module are provided in the microphone acoustic cavity, the signal output end of the transducer is connected with the special integrated circuit module; the transducer and the specific integrated circuit module are arranged on the first layer structure.

Preferably, the dustproof component is electrically connected with the first layer structure or the second layer structure.

Preferably, it is applied to MEMS microphone.

Advantages: Due to the above mentioned technical solution, the invention can prevent most of the dust particles, the moisture and the siphoning effect in actual use, and the external size of the existing microphone does not need to be changed. Consequently, it can be used in the microphone structures which are very thin, and can prolong the microphone service life.

### BRIEF DESCRIPTIONS OF THE DRAWINGS

FIG. 1 is a structure schematic of a system in the present invention;

FIG. 2 is a structure schematic of another system in the present invention;

FIG. 3 is a structure schematic of a dust component in the present invention;

FIG. 4 is a side view of FIG. 3.

### DETAILED DESCRIPTION

The present invention will be further illustrated in combination with the following Figures and embodiments. However, it should not be deemed as limitations of the present invention.

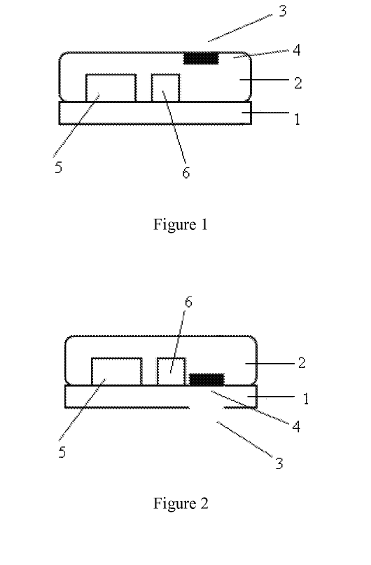

Referring to FIGS. 1 and 2, a new-type microphone structure, comprising: a First Layer Structure 1, a Second Layer Structure 2 located on First Layer Structure 1, and a microphone acoustic cavity formed by First Layer Structure 1 and Second Layer Structure 2; at least one Acoustic Hole 3 for acquiring sound signals is arranged on the microphone acoustic cavity, and a dustproof component covers the inside of Acoustic Hole 3.

The invention aims to attach a Dustproof Component 4 with the inside of Acoustic Hole 3 without changing the microphone monomer volume, and it can be used in microphone structure which is very thin, and can prolong the service life of the microphone. Moreover, sound conducting rubber sleeve which is set as the peripheral does not need to change its size, which is convenient.

Dustproof Component 4 is located on the inner surface of the microphone acoustic cavity and is close to Acoustic Hole 3; at least a portion of Acoustic Hole 3 is covered by Dustproof Component 4. Preferably, Acoustic Hole 3 can be completely covered by Dustproof Component 4 to ensure a good barrier effect of the dust particles.

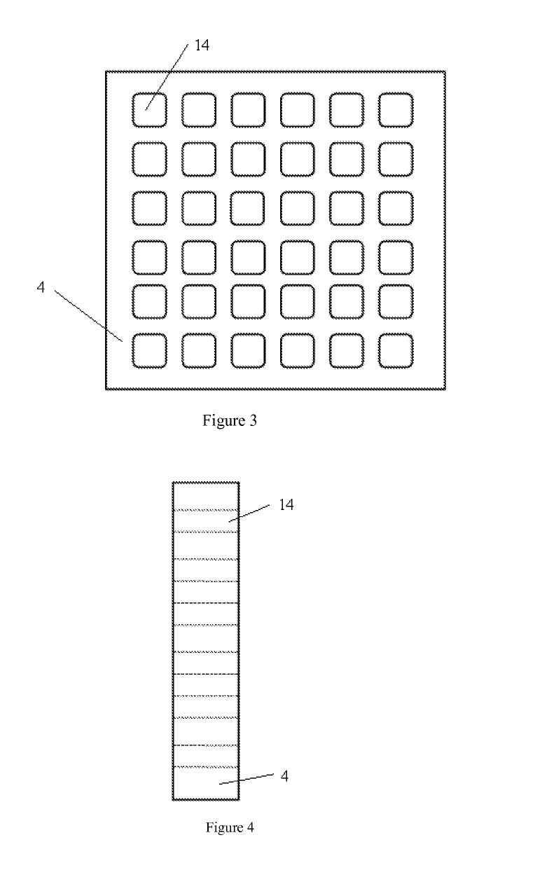

Dustproof Component 4 is a monolayer structure or a multilayer structure. Preferably, Dustproof Component 4 is made of silicon based materials. Referring to FIGS. 3 and 4, Dustproof Component 4 is provided with one or more Filter Holes 14, and a plurality of Filtering Holes 14 forms an array structure.

Acoustic Hole 3 is located in First Layer Structure 1 or Second Layer Structure 2, and can communicate with the outside. In a particular embodiment, referring to FIG. 1, Acoustic Hole 3 is located at the top of First Layer Structure 1, which forms a upward hole, simultaneously, Dustproof Component 4 is located in the upward hole, and is close to the inner surface of First Layer Structure 1; referring to FIG. 2, Acoustic Hole 3 is at the top of Second Layer Structure 2, which forms a downward hole, simultaneously, Dustproof Component 4 is located in the downward hole, and is close to the inner surface of Second Layer Structure 2; Acoustic Hole 3 can also be located in the side of First Layer Structure 1, which forms a sideward hole, simultaneously, Dustproof Component 4 is located in the sideward hole, and is close to the inner surface of the microphone acoustic cavity.

Dustproof Component 4 may connect with First Layer Structure 1 or Second Layer Structure 2 electrically, and then to the ground. Or Dustproof Component 4 is electrically insulated with First Layer Structure 1 or Second Layer Structure 2.

Preferably, in the microphone acoustic cavity, there is a Transducer 5 and a Special Integrated Circuit Module 6. The output signal end of the Transducer 5 is connected with Special Integrated Circuit Module 6; Transducer 5 and Specific Integrated Circuit Module 6 are arranged on First Layer Structure1. First Layer Structure 1 is a substrate layer.

The invention is applied to MEMS microphone. The outer walls of the microphone acoustic cavity form the external casing of the MEMS microphone.

While the present disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A new-type microphone structure, comprising: a first layer structure and a second layer structure located on the first layer structure, a microphone acoustic cavity formed by the first layer structure and the second layer structure, at least one acoustic hole for acquiring sound signals is arranged on the microphone acoustic cavity, and a dustproof component covers the inside of the acoustic hole.

2. A new-type microphone structure as disclosed in claim 1, wherein the dustproof component is located on the inner surface of the microphone acoustic cavity.

3. A new-type microphone structure as disclosed in claim 1, wherein at least one portion of the acoustic hole is covered with the dustproof component.

4. A new-type microphone structure as disclosed in claim 1, wherein the acoustic hole is located on the first layer or the second layer to enable the microphone acoustic cavity to be connected with the outside.

5. A new-type microphone structure as disclosed in claim 1, wherein the dustproof component is a monolayer structure or a multilayer structure.

6. A new-type microphone structure as disclosed in claim 5, wherein the dustproof component is made of silicon based materials.

7. A new-type microphone structure as disclosed in claim 1, wherein the dustproof component is provided with a plurality of filter holes which forms into an array structure after the rearrangement.

8. A new-type microphone structure as disclosed in claim 1, wherein a transducer and a special integrated circuit module are provided in the microphone acoustic cavity, the signal output end of the transducer is connected with the special integrated circuit module; the transducer and the specific integrated circuit module are arranged on the first layer structure.

9. A new-type microphone structure as disclosed in claim 1, wherein the dustproof component is electrically connected with the first layer structure or the second layer structure.

10. A new-type microphone structure as disclosed in claim 1, wherein it is applied to MEMS microphone.
